(19) United States
(12) Patent Application Publication
(10) Pub. No.: US 2026/0024919 A1
(43) Pub. Date: Jan. 22, 2026

(54) INTELLIGENT REFLECTING SURFACE

(71) Applicant: Japan Display Inc., Tokyo (JP)

(72) Inventors: Mitsuhiro SUGAWARA, Tokyo (JP); Kazuki MATSUNAGA, Tokyo (JP)

(73) Assignee: Japan Display Inc., Tokyo (JP)

(21) Appl. No.: 19/342,856

(22) Filed: Sep. 29, 2025

Related U.S. Application Data
(63) Continuation of application No. PCT/JP2024/010265, filed on Mar. 15, 2024.

(30) Foreign Application Priority Data
Mar. 30, 2023 (JP) 2023-055730

(51) Int. Cl. H01Q 15/14

(52) U.S. Cl. CPC H01Q 15/147

(57) ABSTRACT

An intelligent reflecting surface (reflect array) includes a plurality of common electrodes arranged in a matrix in a first direction and a second direction intersecting the first direction, a plurality of bias electrodes overlapping the plurality of common electrodes, a liquid crystal layer between the plurality of common electrodes and the plurality of bias electrodes, and a strip wiring connecting the plurality of common electrodes in series in an array in the first direction or the second direction. The strip wiring includes a first wiring length for connecting pairs of common electrodes disposed in a center part and a second wiring length different from the first length for connecting pairs of common electrodes disposed in an outer part, in the array of the plurality of common electrodes in the first direction or the second direction.

### CROSS-REFERENCE TO RELATED APPLICATIONS

This application is a Continuation of International Patent Application No. PCT/JP2024/010265, filed on Mar. 15, 2024, which claims the benefit of priority to Japanese Patent Application No. 2023-055730, filed on Mar. 30, 2023, the entire contents of each are incorporated herein by reference.

### FIELD

An embodiment of the present invention relates to a radio wave reflector (hereinafter also referred to as “intelligent reflecting surface” or “reflect array”) capable of changing the reflecting direction of radio waves, particularly an embodiment of the present invention relates to an intelligent reflecting surface (reflect array) using a liquid crystal material.

### BACKGROUND

An intelligent reflecting surface (reflect array) is used to deliver radio waves to areas where radio waves are not accessible, such as canyons of tall buildings. As an intelligent reflecting surface (reflect array), for example, a configuration is disclosed where a main array element (dipole element), a sub-array element (passive element) and a common electrode (ground electrode) are provided across a dielectric substrate, and the sub-array element is provided close to the main array element (refer to Japanese laid-open patent publication No. 2011-019021), and a configuration is disclosed where an array element and a common electrode (ground electrode) sandwich a dielectric substrate and the common electrode has a periodic loop shape (refer to Japanese laid-open patent publication No. 2010-226695).

The intelligent reflecting surface (reflect array) uses a dielectric substrate, and when the part corresponding to the dielectric substrate is replaced with a liquid crystal layer, the dielectric anisotropy of the liquid crystal material can be utilized, and the directivity of the reflected wave can be made variable. The intelligent reflecting surface (reflect array) using a liquid crystal material has a structure similar to planar array antennas with patch arrays.

A radio wave reflected by the intelligent reflecting surface (reflect array) generates a main lobe reflected at a desired angle and a side lobe reflected obliquely and laterally with respect to the desired angle. Since the side lobes are not radio waves that are reflected in the desired direction, when the side lobes are large, the reflection gain is reduced, and there is a risk that noise is caused and the communication quality of the receiving side is degraded.

### SUMMARY

An intelligent reflecting surface (reflect array) in an embodiment according to the present invention includes a plurality of common electrodes arranged in a matrix in a first direction and a second direction intersecting the first direction, a plurality of bias electrodes overlapping the plurality of common electrodes, a liquid crystal layer between the plurality of common electrodes and the plurality of bias electrodes, and a strip wiring connecting the plurality of common electrodes in series in an array in the first direction or the second direction. The strip wiring includes a first wiring length for connecting pairs of common electrodes disposed in a center part and a second wiring length different from the first wiring length, for connecting pairs of common electrodes disposed in an outer part, in the array of the plurality of common electrodes in the first direction or the second direction.

An intelligent reflecting surface (reflect array) in an embodiment according to the present invention includes a plurality of bias electrodes arranged in a matrix in a first direction and a second direction intersecting the first direction, a common electrode overlapping the plurality of bias electrodes, a liquid crystal layer between the plurality of bias electrodes and the common electrode, and a strip wiring connecting the plurality of bias electrodes to each other in an array in the first direction or the second direction. The strip wiring includes a first wiring length for connecting pairs of bias electrodes disposed in a center part and a second wiring length different from the first wiring length, for connecting pairs of bias electrodes disposed in an outer part, in the array of the plurality of bias electrodes in the first direction or the second direction.

### BRIEF DESCRIPTION OF DRAWINGS

FIG. 1 is a plan view showing a configuration of an intelligent reflecting surface (reflect array) according to an embodiment of the present invention.

FIG. 2 is a cross-sectional view showing the structure of the intelligent reflecting surface (reflect array) corresponding to A1-A2 shown in FIG. 1.

FIG. 3 is a plan view showing a unit cell configuring an intelligent reflecting surface (reflect array) according to an embodiment of the present invention.

FIG. 4 is a cross-sectional view showing the structure of the intelligent reflecting surface (reflect array) corresponding to B1-B2 shown in FIG. 3.

FIG. 5A is a schematic diagram illustrating an operation of a unit cell configuring an intelligent reflecting surface (reflect array) according to an embodiment of the present invention, and shows a state in which a bias voltage is not applied to the liquid crystal layer.

FIG. 5B is a schematic diagram illustrating an operation of a unit cell configuring an intelligent reflecting surface (reflect array) according to an embodiment of the present invention, and shows a state in which a bias voltage is applied to the liquid crystal layer.

FIG. 6 is a schematic view showing a change in the traveling direction of a scattered wave by an intelligent reflecting surface (reflect array) according to an embodiment of the present invention.

FIG. 7A is a diagram showing a configuration of a common electrode and a strip wiring connecting pairs of common electrodes configuring a unit cell according to an embodiment of the present invention.

FIG. 7B is a diagram showing a configuration of a common electrode and a strip wiring connecting pairs of common electrodes configuring a unit cell according to an embodiment of the present invention.

FIG. 8 is a schematic diagram illustrating that the amplitude of the reflected wave can be fitted to a Taylor distribution by varying the length of the strip wiring.

FIG. 9 is a schematic diagram showing the results of calculating the array factor of a one-dimensional unit cell array in an embodiment of the present invention.

FIG. 10 is a plan view showing a configuration of an intelligent reflecting surface (reflect array) according to an embodiment of the present invention.

FIG. 11 is a cross-sectional view showing the structure of the intelligent reflecting surface (reflect array) corresponding to C1-C2 shown in FIG. 10.

FIG. 12 is a schematic diagram for explaining the array factor obtained in the first embodiment.

### DESCRIPTION OF EMBODIMENTS

Hereinafter, embodiments of the present invention are described with reference to the drawings. However, the present invention can be implemented in many different aspects and should not be construed as being limited to the description of the following embodiments. For the sake of clarifying the explanation, the drawings may be expressed schematically with respect to the width, thickness, shape, and the like of each part compared to the actual aspect, but this is only an example and does not limit the interpretation of the present invention. For this specification and each drawing, elements similar to those described previously with respect to previous drawings may be given the same reference sign (or a number followed by A, B, etc.) and a detailed description may be omitted as appropriate. The terms “first” and “second” appended to each element are a convenience sign used to distinguish them and have no further meaning except as otherwise explained.

As used herein, where a member or region is “on” (or “below”) another member or region, this includes cases where it is not only directly on (or just under) the other member or region but also above (or below) the other member or region, unless otherwise specified. That is, it includes the case where another component is included in between above (or below) other members or regions.

### First Embodiment

An intelligent reflecting surface (reflect array) according to the present embodiment has a structure where a common electrode is provided on the radio wave incident side, and a bias electrode is provided on the back side of the common electrode, separated by a liquid crystal layer used as a dielectric layer. The details are described below with reference to the figures.

### 1-1. Intelligent Reflecting Surface (Reflect Array)

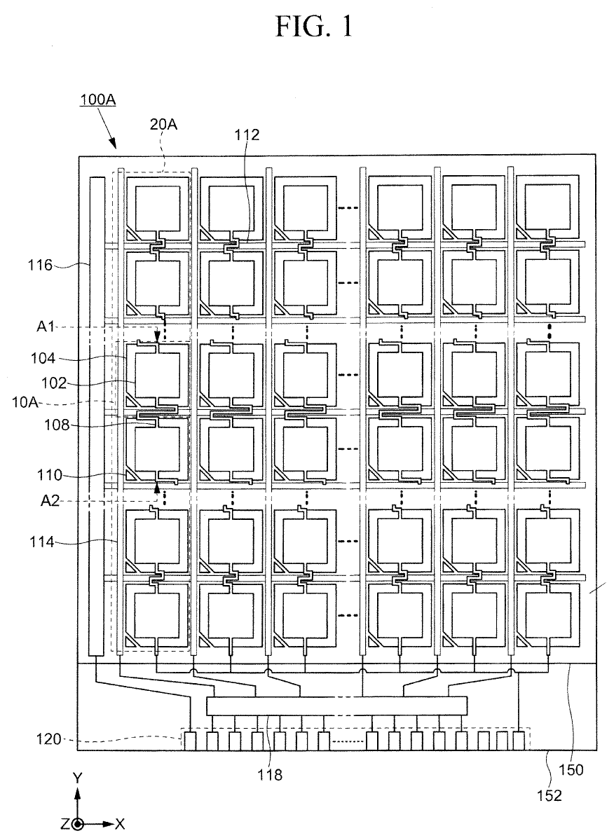

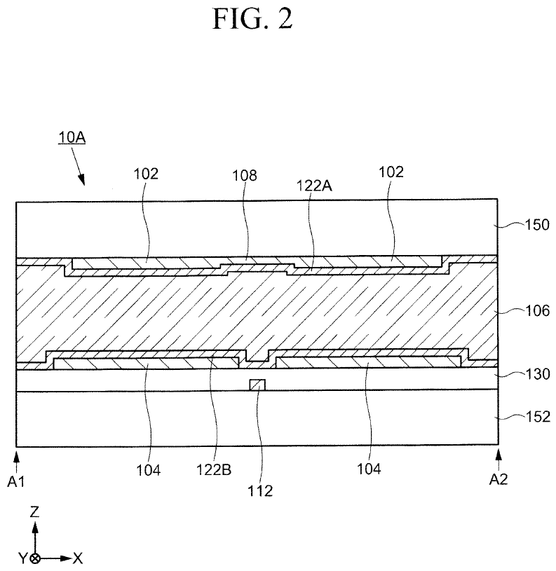

FIG. 1 shows a plan view of the intelligent reflecting surface (reflect array) 100A according to the present embodiment. FIG. 2 shows a cross-sectional structure of the intelligent reflecting surface (reflect array) 100A corresponding to A1-A2 shown in FIG. 1. As shown in FIG. 1 and FIG. 2, the intelligent reflecting surface (reflect array) 100A includes a common electrode 102, a bias electrode 104, and a liquid crystal layer 106 provided between the common electrode 102 and the bias electrode 104.

As shown in FIG. 1, the common electrodes 102 are provided in a matrix in an X-axis direction and a Y-axis direction. The bias electrodes 104 are provided in a matrix in the X-axis direction and the Y-axis direction to correspond to the common electrodes 102. The common electrode 102 and the bias electrode 104 are disposed to overlap in a plan view. It is to be noted that the X-axis direction and the Y-axis direction are used for the purpose of explanation and refer to the directions shown in FIG. 1. The X-axis direction and the Y-axis direction may be replaced with the first direction and the second direction intersecting the first direction.

As shown in FIG. 2, the common electrode 102 is provided on a first substrate 150, and the bias electrode 104 is provided on a second substrate 152. A surface of the first substrate 150 provided with the common electrode 102 and a surface of the second substrate 152 provided with the bias electrode 104 are disposed to face each other, and the liquid crystal layer 106 is provided therebetween. The intelligent reflecting surface (reflect array) 100A controls the reflection direction of the incident radio wave by changing the orientation state of the liquid crystal molecules composing the liquid crystal layer 106. The liquid crystal layer 106 includes liquid crystal molecules whose orientation is changed by a potential difference between the common electrode 102 and the bias electrode 104. Therefore, the common electrode 102, the liquid crystal layer 106, and the bias electrode 104 are basic units of operation. In this embodiment, this basic unit will be referred to as a unit cell 10A for convenience of explanation.

The common electrode 102 has a planar shape similar to that of a patch antenna and is spaced apart from each unit cell 10A. The bias electrode 104 is provided corresponding to the common electrode 102. The intelligent reflecting surface (reflect array) 100A may have a structure in which such unit cells 10A are provided in a matrix in the X-axis direction and the Y-axis direction. The number of unit cells 10 provided in the X-axis direction and the Y-axis direction is not limited, but 10 or more, preferably 16 or more, are provided in the Y-axis direction.

The common electrode 102 is connected to another common electrode 102 adjacent in the array in the Y-axis direction by a strip wiring 108. FIG. 1 shows a structure in which the common electrodes 102 provided in the Y-axis direction are connected to each other by the strip wiring 108. On the other hand, the bias electrode 104 is provided in a state of being physically and electrically separated from an adjacent bias electrode 104. Therefore, the unit cells 10A arranged in the Y-axis direction have a structure in which a common voltage is applied to the common electrode 102 and a bias signal can be applied to the bias electrode 104 individually. In the present embodiment, an arrangement of the unit cells 10A in the Y-axis direction is referred to as a unit cell array 20A for convenience of explanation.

A predetermined constant voltage is applied or grounded as a common voltage to the common electrode 102. Since the common electrodes 102 are connected to each other by the strip wiring 108, the same common voltage is applied to the common electrodes 102 of the unit cell array 20A. Although the same common voltage is applied to the common electrodes 102 for each array in the Y-axis direction, it is also possible to apply the same common voltage to all of the common electrodes 102 provided in the plane of the intelligent reflecting surface (reflect array) 100A.

The intelligent reflecting surface (reflect array) 100A includes a selection signal line 112 extending in the X-axis direction, a bias signal line 114 extending in the Y-axis direction, and a switching element 110. The selection signal line 112, the bias signal line 114, and the switching element 110 are provided on the second substrate 152. The selection signal line 112 extends in the X-axis direction, and the bias signal line 114 extends in the Y-axis direction. The switching element 110 is provided for each unit cell 10A. The switching element 110 is controlled to be in an ON state and an OFF state by a selection signal of the selection signal line 112. When the switching element 110 is in the ON state, a bias voltage based on the bias signal is applied from the bias signal line 114 to the bias electrode 104.

Although the selection signal line 112 and the bias signal line 114 are disposed to cross each other, these wirings are insulated by providing an interlayer insulating layer 130 on the second substrate 152. As shown in FIG. 1, the second substrate 152 may be provided with a selection signal line driving circuit 116 for outputting a selection signal to the selection signal line 112, a bias signal line driving circuit 118 for outputting a bias signal to the bias signal line 114, and a terminal 120 for inputting a control signal from an external circuit.

The intelligent reflecting surface (reflect array) 100A is a device for reflecting radio waves incident on an incident surface in a predetermined direction, wherein the first substrate 150 is disposed on the incident surface side of the radio waves and the second substrate 152 is disposed on the back side. That is, the common electrode 102 is provided on the incident surface of the radio wave, and the bias electrode 104 is provided on the back surface of the common electrode 102 with the liquid crystal layer 106 sandwiched therebetween. The intelligent reflecting surface (reflect array) 100A can control the orientation state of the liquid crystal layer 106 for each unit cell 10A by applying a constant voltage to the common electrode 102 and applying individual bias voltages to the bias electrode 104.

The liquid crystal layer 106 contains liquid crystal molecules elongated in a rod shape. Since the liquid crystal molecules have dielectric constant anisotropy, the dielectric constant is changed by changing the orientation state of the liquid crystal molecules. The phase of the radio wave reflected by the intelligent reflecting surface (reflect array) 100A varies depending on the dielectric constant of the liquid crystal layer 106. It is possible to control the traveling direction (reflection direction) in an intended direction by changing the dielectric constant of the liquid crystal layer 106 for each unit cell 10A in the plane of the intelligent reflecting surface (reflect array) 100A to generate a phase difference in the reflected radio waves.

The initial orientation state of the liquid crystal molecules in the liquid crystal layer 106 (orientation state in a state where a bias voltage is not applied) is defined by the alignment film. As shown in FIG. 2, a first alignment film 122A is disposed on the first substrate 150, and a second alignment film 122B is disposed on the second substrate 152. The first alignment film 122A is disposed to cover the common electrode 102, and the second alignment film 122B is disposed to cover the bias electrode 104. The first alignment film 122A and the second alignment film 122B need only have the function of aligning the liquid crystal molecules, and the material and the manufacturing method are not limited. As the first alignment film 122A and the second alignment film 122B, a vertical alignment film, a horizontal alignment film or the like is appropriately selected in accordance with the type of liquid crystal. The first alignment film 122A and the second alignment film 122B are formed of, for example, polyimide.

As shown in FIG. 1 and FIG. 2, the intelligent reflecting surface (reflect array) 100A has a structure similar to that of a liquid crystal display panel in which a liquid crystal layer 106 is provided between a pair of opposing electrodes (the common electrode 102 and the bias electrode 104), but differs in that the liquid crystal layer 106 is thick and the common electrode 102 and the bias electrode 104 are not transparent, as will be described later. Instead, the intelligent reflecting surface (reflect array) 100A can be regarded as a patch antenna in which a patch electrode (the common electrode 102) is disposed on the upper surface of a dielectric (the liquid crystal layer 106) and a reflecting electrode (bias electrode) is disposed on the back surface.

### 1-2. Unit Cell

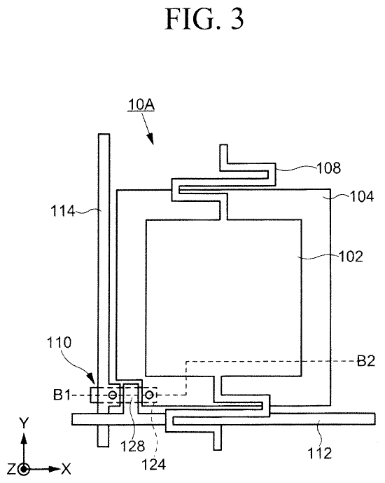

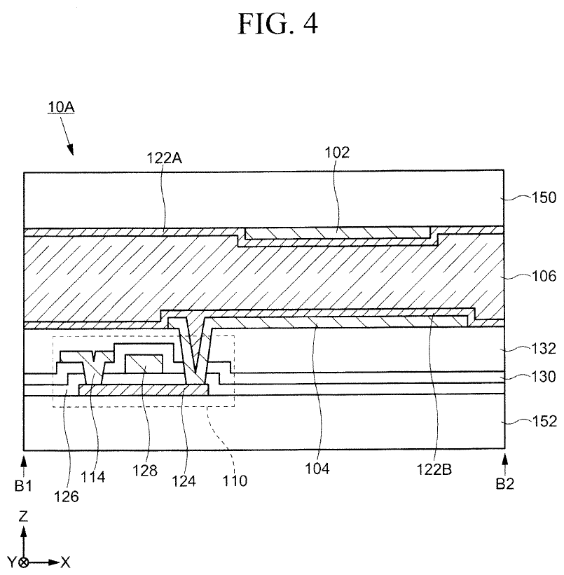

FIG. 3 and FIG. 4 show details of the unit cell 10A configuring the intelligent reflecting surface (reflect array) 100A. FIG. 3 shows a plan view of the unit cell 10A, and FIG. 4 shows a cross-sectional structure of the unit cell 10A corresponding to B1-B2 shown in FIG. 3.

As shown in FIG. 3 and FIG. 4, the common electrode 102, the liquid crystal layer 106, and the bias electrode 104 of the unit cell 10A overlap in a plan view. FIG. 3 shows an example in which the common electrode 102 has a square shape in a plan view. However, the shape of the common electrode 102 is not limited to the shape shown in FIG. 3, and may be rectangular, or may be geometrically shaped such that corners of the rectangle are cut off. The size (vertical and horizontal length) of the common electrode 102 is appropriately determined in accordance with the frequency of the target radio wave. The vertical and horizontal dimensions of the common electrode 102 can be determined to have a symmetrical shape with respect to the vertical polarization and the horizontal polarization of the incident radio wave.

The common electrode 102 is connected to the strip wiring 108. The strip wiring 108 is connected to the center of one side of the common electrode 102. In other words, the strip wiring 108 is connected so that the center part of one side of the common electrode 102 is included in the width portion of the strip wiring 108. The connection structure between the strip wiring 108 and the common electrode 102 is not limited. For example, the strip wiring 108 and the common electrode 102 may be formed of the same conductive layer, or the strip wiring 108 and the common electrode 102 may be disposed across an interlayer insulating layer and connected via a contact hole.

The strip wiring 108 is a wiring for connecting the common electrodes 102 arranged in the Y-axis direction. As will be described later, while the intervals of the common electrodes 102 arranged in the Y-axis direction are constant, the lengths of the strip wiring 108 vary depending on the positions of the unit cells 10A arranged in the Y-axis direction. FIG. 1 shows two-unit cells: the unit cell 10A provided at the center of the unit cell array 20A and the unit cell 10A provided at the edge (outer side) of the unit cell array 20A, and the length of the strip wiring 108 of the unit cell array 20A is longer at the center and gradually changes (becoming progressively shorter) as it moves outward from the center.

The bias electrode 104 has a larger area than the common electrode 102 in order to function as a reflection plate. The bias electrode 104 and the common electrode 102 are disposed to overlap each other, and the common electrode 102 is disposed to fit inside the bias electrode 104. The bias electrode 104 is connected to a bias signal line 114 through a switching element 110.

FIG. 3 and FIG. 4 show an example in which the switching element 110 is formed of a transistor. The transistor has a structure in which a semiconductor layer 124, a gate insulating layer 126, and a gate electrode 128 are laminated. The interlayer insulating layer 130 is disposed on the gate electrode 128, and the bias signal line 114 is disposed thereon. The switching element 110 and the bias signal line 114 are embedded with a planarization layer 132. The bias electrode 104 is disposed on a flat surface above the planarization layer 132. The bias electrode 104 is connected to an input/output terminal (drain) of the switching element 110 (transistor) via a contact hole. The gate electrode 128 of the switching element 110 (transistor) is connected to the selection signal line 112, and an input/output terminal (source) not connected to the bias electrode 104 is connected to the bias signal line 114.

An electric field is generated between the bias electrode 104 and the common electrode 102 to change the orientation of the liquid crystal molecules, by applying a bias voltage based on a predetermined bias signal to the bias electrode 104. That is, the orientation of the liquid crystal molecules in the liquid crystal layer 106 is changed by the bias signal applied to the bias electrode 104. The bias signal is a DC voltage signal or a polarity inverted DC voltage signal in which a positive DC voltage and a negative DC voltage are alternately inverted.

The liquid crystal layer 106 is formed of a liquid crystal material having liquid crystal properties and dielectric constant anisotropy. Both positive and negative dielectric anisotropy of liquid crystal materials are applicable. The liquid crystal layer 106 is formed of, for example, nematic liquid crystal.

The frequency bands of radio waves reflected by the intelligent reflecting surface (reflect array) 100A include a very high frequency (VHF) band, an ultra-high frequency (UHF) band, a super high frequency (SHF) band, a sub-millimeter wave (THF) band, a millimeter wave (EHF) band, and a terahertz wave band. Although the orientation state of the liquid crystal molecules in the liquid crystal layer 106 is changed by a bias signal (bias voltage) applied to the bias electrode 104, the liquid crystal molecules hardly follow the frequency of the radio wave incident on the common electrode 102. Since the orientation of the liquid crystal molecules does not change following a high frequency, the intelligent reflecting surface (reflect array) 100A has a function of changing the dielectric constant of the liquid crystal layer 106 by the bias electrode 104 and simultaneously reflecting a radio wave by the common electrode 102 to change the phase of the reflected radio wave.

The first substrate 150 and the second substrate 152 are used for sandwiching the liquid crystal layer 106 and forming the common electrode 102, the bias electrode 104, and the strip wiring 108. The first substrate 150 and the second substrate 152 are formed of a dielectric material such as glass or resin, and have a flat plate shape.

The respective layers of the first substrate 150 and the second substrate 152 are formed of the following materials. The semiconductor layer 124 is provided for forming the switching element 110, and is formed of a silicon semiconductor such as amorphous silicon, polycrystalline silicon, or an oxide semiconductor including a metal oxide such as indium oxide, zinc oxide, or gallium oxide. The gate insulating layer 126 and the interlayer insulating layer 130 are formed of, for example, a silicon oxide film, a silicon nitride film, or a laminated structure thereof. The selection signal line 112 and the gate electrode 128 are made of, for example, molybdenum (Mo), tungsten (W), or an alloy thereof. The bias signal line 114 is formed of, for example, a stacked structure of titanium (Ti)/aluminum (Al)/titanium (Ti) or a stacked structure of molybdenum (Mo)/aluminum (Al)/molybdenum (Mo). The planarization layer 132 is disposed to planarize irregularities formed by providing the selection signal line 112, the bias signal line 114, the switching element 110, and the like on the second substrate 152. The planarization layer 132 is formed of an organic material such as an acrylic resin, an epoxy resin, or a polyimide material. The common electrode 102, the bias electrode 104, and the strip wiring 108 are formed of, for example, aluminum, copper, gold, or an alloy thereof.

The gap between the first substrate 150 and the second substrate 152 is approximately 20 μm to 100 μm, and has a gap of, for example, 40 μm. The first substrate 150 and the second substrate 152 sandwich the liquid crystal layer 106 and are bonded together by a sealing material (not shown). The sealing material may be formed of, for example, an acrylic or epoxy adhesive as long as it has a function of bonding the first substrate 150 and the second substrate 152. The liquid crystal layer 106 is enclosed in a region surrounded by the first substrate 150, the second substrate 152 and the sealing material. Although not shown, spacers may be provided between the first substrate 150 and the second substrate 152 to keep the gap constant.

### 1-3. Operation of Unit Cell

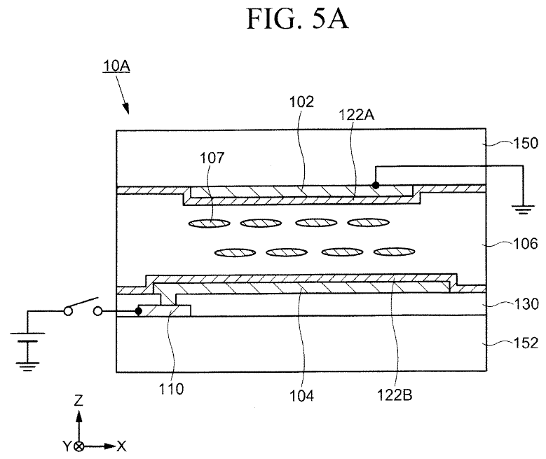

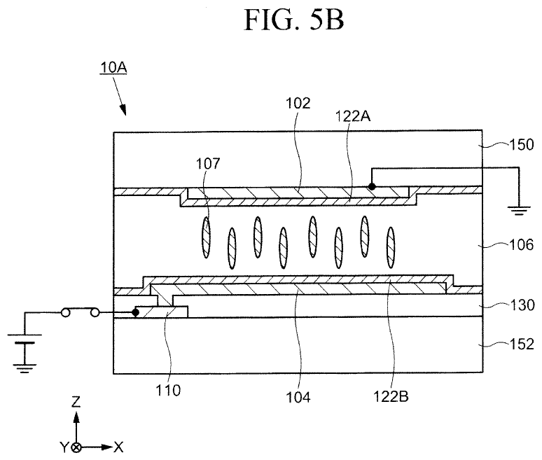

FIG. 5A and FIG. 5B show two states of the unit cell 10A. FIG. 5A and FIG. 5B show the case where the first alignment film 122A and the second alignment film 122B are horizontal alignment films. FIG. 5A shows a state in which a bias voltage is not applied to the bias electrode 104. That is, FIG. 5A shows a state where a voltage higher than the threshold value of the liquid crystal is not applied to the bias electrode 104 at a level that changes the orientation state of the liquid crystal molecules 107. Hereinafter, this state will be referred to as a “first state”. FIG. 5A shows a state in which, in the first state, the long axis of the liquid crystal molecules 107 is oriented substantially horizontally by the alignment regulating force of the first alignment film 122A and the second alignment film 122B (initial orientation state). That is, in the first state, the long axis direction of the liquid crystal molecules 107 is oriented substantially horizontally with respect to the surfaces of the common electrode 102 and the bias electrode 104.

FIG. 5B shows a state in which a voltage level for changing the orientation state of the liquid crystal molecules 107, that is, a bias voltage higher than the threshold value of the liquid crystal, is applied to the bias electrode 104. Hereinafter, this state will be referred to as a “second state”. In the second state, the long axis direction of the liquid crystal molecules 107 is influenced by the electric field generated by the bias voltage and is oriented substantially perpendicular to the surfaces of the common electrode 102 and the bias electrode 104. The angle at which the long axis of the liquid crystal molecules 107 is oriented can be controlled by the magnitude of a bias signal applied to the bias electrode 104, and it is also possible to orient the liquid crystal molecules at an angle between horizontal and vertical.

When the liquid crystal molecules 107 have positive dielectric constant anisotropy, the dielectric constant in the direction along the Z-axis direction is larger in the second state (FIG. 5B) than in the first state (FIG. 5A). When the liquid crystal molecules 107 have negative dielectric constant anisotropy, the dielectric constant in the apparent direction along the Z-axis direction is smaller in the second state (FIG. 5B) than in the first state (FIG. 5A). The liquid crystal layer 106 formed of a liquid crystal having dielectric constant anisotropy can be regarded as a variable dielectric layer. The unit cell 10A can be controlled to delay (or not delay) the phase of the reflected radio wave by utilizing the dielectric anisotropy of the liquid crystal layer 106.

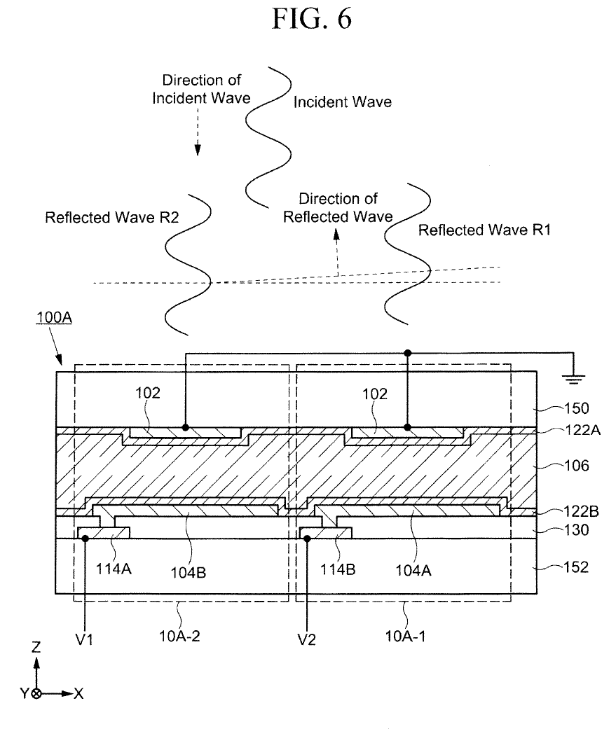

FIG. 6 schematically shows how the traveling direction of the radio wave reflected by the first unit cell 10A-1 and the second unit cell 10A-2 changes. A bias signal V1 is applied from a bias signal line 114A to a bias electrode 104A of the first unit cell 10A-1, and a bias signal V2 is applied from a bias signal line 114B to a bias electrode 104B of the second unit cell 10A-2. Here, the voltage levels of the bias signal V1 and the bias signal V2 are different (V1≠V2). The common electrodes 102 of the first unit cell 10A-1 and the second unit cell 10A-2 have the same potential and are grounded, for example.

FIG. 6 schematically shows a state in which a radio wave incident on the intelligent reflecting surface (reflect array) 100A is reflected. FIG. 6 shows a state in which different bias signals (V1≠V2) are applied to the first unit cell 10A-1 and the second unit cell 10A-2, so that the phase of the reflected wave by the second unit cell 10A-2 is delayed compared with that of the first unit cell 10A-1. As a result, the reflected wave travels in an oblique direction (leftward direction when the drawing is viewed directly).

FIG. 6 schematically shows two-unit cells, but actually, as shown in FIG. 1, unit cells 10A are arranged in a matrix. The intelligent reflecting surface (reflect array) 100A can control the traveling direction of the reflected wave in an intended direction without changing the direction of the incident surface of the radio wave (the direction in which the first substrate 150 and the second substrate 152 face) by individually controlling the unit cells 10A arranged in a matrix.

### 1-4. Unit Cell Array

It is required that directivity and reflection gain are high, and that interference and noise are not included in the reflected wave as some of the capabilities of the intelligent reflecting surface (reflect array) 100A. The radio wave reflected by the intelligent reflecting surface (reflect array) 100A includes a main lobe reflected in a desired angular direction and a component called side lobes reflected in an unintended oblique or lateral direction. Since the side lobes cause interference from the surroundings and an increase in noise, it is necessary to reduce the level of the side lobes in order to increase the directivity and obtain good reflection characteristics.

The intelligent reflecting surface (reflect array) 100A according to the present embodiment has a configuration in which the amplitude distribution of reflected radio waves is a Taylor distribution in order to reduce the side lobe level. A configuration for making the amplitude distribution of reflected waves of the intelligent reflecting surface (reflect array) 100A into a Taylor distribution will be described below.

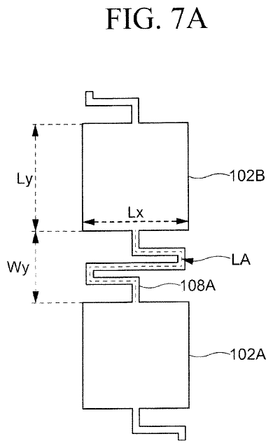

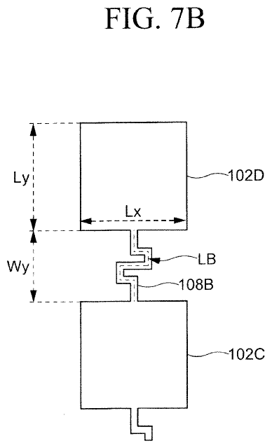

FIG. 7A and FIG. 7B show a partial structure of the unit cell array 20A shown in FIG. 1. FIG. 7A shows a common electrode 102A and a common electrode 102B disposed adjacently in the center part of the unit cell array 20A, and a strip wiring 108A connecting the common electrode 102A and the common electrode 102B. FIG. 7B shows a strip wiring 108B connecting a common electrode 102C and a common electrode 102D disposed adjacently at an end (outer part) of the unit cell array 20A and the common electrode 102C and the common electrode 120D.

As shown in FIG. 7A, the common electrode 102A has a length Lx in a direction along the X-axis direction and a length Ly in a direction along the Y-axis direction in a plan view. The length Lx and the length Ly are determined to be optimal in accordance with the frequency of the radio wave targeted by the intelligent reflecting surface (reflect array) 100A. The common electrodes 102B, 102C and 102D have the same dimensions in a plan view. As shown in FIG. 7A, a spacing Wy between the common electrode 102A and the common electrode 102B and a spacing Wy between the common electrode 102C and the common electrode 102D are the same. That is, the common electrodes 102 are arranged at equal intervals in the unit cell array 20A. The spacing Wy is generally designed to be smaller than the length Lx and the length Ly in order to arrange the common electrodes 102 at a high density. Thus, in the unit cell array 20A, the length Lx and the length Ly of the common electrode 102 and the spacing Wy between the adjacent common electrodes are constant.

On the other hand, as shown in FIGS. 7A and 7B, a wiring length LA of the strip wiring 108A connecting the common electrode 102A and the common electrode 102B is different from a wiring length LB of the strip wiring 108B connecting the common electrode 102C and the common electrode 102D. The wiring length LA is a length along the center line of the wiring from the point where the strip wiring 108A is connected to the common electrode 102A to the point where the strip wiring 108A is connected to the common electrode 102B. The same applies to the wiring length LB.

The size of the common electrode 102 is preferably such that the length Ly of the common electrode 102 is a half wavelength with respect to the wavelength λ of the vertically polarized wave, for example, when the intelligent reflecting surface (reflect array) 100A reflects a vertically polarized wave having an amplitude in a direction parallel to one side of the common electrode 102 extending in the Y-axis direction. The length LA of the strip wiring 108A is preferably the same as the length Ly of one side of the common electrode 102. However, since the spacing Wy (linear distance) between the adjacent common electrodes is smaller than the length Ly of one side of the common electrode 102, the strip wiring 108A has a shape bent a plurality of times in a meander shape (or a crank shape) in a plane view in order to make the wiring length longer than the spacing Wy. In other words, the strip wiring 108A connecting the common electrode 102A and the common electrode 102B has a bent shape having a plurality of bending points between one end and the other end in a plan view. By adopting such a bent shape, the strip wiring 108A having a predetermined length can be provided at a spacing Wy narrower than the length Ly of one side of the common electrode 102.

Here, the wavelength λ is a wavelength when a vertically polarized wave propagates in air, and the apparent wavelength λg when propagating through the liquid crystal layer 106 (dielectric layer) is expressed by the following equation (1) on the basis of the relative permittivity εₛ of the dielectric layer.

$$λ g = \frac{λ}{{( {ε}_{s} )}^{\frac{1}{2}}} \qquad ( 1 )$$

Therefore, when the side length Ly of the common electrodes 102A and 102B and the wiring length LA of the strip wiring 108A have a length of λg/2, the amplitude of the reflected wave is maximum. In other words, even if the length Ly of the common electrode 102 is constant, the amplitude of the reflected wave decreases when the wiring length LA of the strip wiring 108A deviates from λg/2.

On the other hand, as shown in FIG. 7B, the wiring length LB of the strip wiring 108B connecting the common electrode 102C to the common electrode 102D has bend with a smaller width and is shorter than the length LA of the strip wiring 108A (LB<LA). That is, the wiring length LB of the strip wiring 108B is smaller than λg/2. Therefore, the amplitudes of the reflected waves of the common electrode 102C and the common electrode 102D become smaller than the amplitudes of the common electrode 102A and the common electrode 102B.

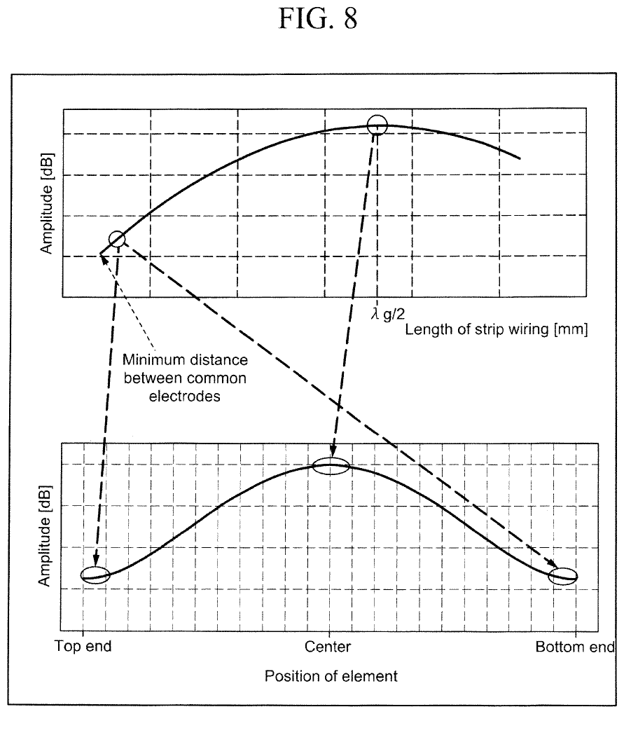

FIG. 8 is a diagram for explaining that the amplitude of the reflected wave is varied according to the length of the strip wiring 108 to conform to the Taylor distribution. In FIG. 8, the graph shown in the upper part shows the result of a simulation of the change in amplitude with respect to the length of the strip wiring. The lower graph in FIG. 8 shows the amplitude value for each unit cell calculated by the calculation formula of the Taylor distribution. The Taylor distribution is calculated as follows according to Reference 1 (C. A. Balanis, “Antenna Theory”, John Wiley & Sons, Inc., 1997, p. 358.).

The Taylor distribution introduces a scaling factor σ shown in Eq. (2).

$$σ = \frac{\overline{n}}{\sqrt{{A}^{2} + {( \overline{n} - \frac{1}{2} )}^{2}}} \qquad ( 2 )$$

In equation (2), “A” is given by equation (3) and equation (4).

$$A = \frac{1}{π} {cosh}^{- 1} R \qquad ( 3 )$$

$$R = 1 {0}^{- SLL / 20} \qquad ( 4 )$$

The position of the null point (the point at which the electric field intensity between lobes becomes minimum) is expressed by using equation (5).

$${u}_{n} = π {u}_{n} = π \frac{l}{λ} cos {θ}_{n} = \{ \begin{matrix}\pm πσ \sqrt{{A}^{2} + {( n - \frac{1}{2} )}^{2}} \\ \pm n π\end{matrix} \qquad ( 5 )$$

The normalized source distribution from which the desired pattern is obtained is given by equation (6).

$$I ( {z}^{′} ) = \frac{λ}{l} [ 1 + 2 {\sum }_{p = l}^{\overline{n} - 1} SF ( p , A , \overline{n} ) cos ( 2 π p \frac{{z}^{′}}{l} ) ] \qquad ( 6 )$$

The space factor SF( ) represents a sample of the Taylor pattern and can also be obtained by using equation (7).

$$SF ( p , A , \overline{n} ) = \{ \begin{matrix}- \frac{{[ ( \overline{n} - 1 ) ! ]}^{2}}{( \overline{n} - 1 + p ) ! ( \overline{n} - 1 - p ) !} {\prod }_{m = 1}^{\overline{n} - 1} [ 1 - {( \frac{π p}{{u}_{m}} )}^{2} ] & \vert p \vert < \overline{n} \\ 0 & \vert p \vert \geq \overline{n}\end{matrix} \qquad ( 7 )$$

In the equations (2) to (7), R is a side lobe level (voltage ratio), SLL is a side lobe level (dB), n̅ is a zero-point alignment position, λ is a wavelength, and uₘ is a null point position.

The upper graph of FIG. 8 shows the result of normalizing the wiring length of the strip wiring by the amplitude of λg/2, and shows that the amplitude (dB) decreases as the wiring length decreases. It is also shown that the amplitude (dB) decreases even if the wiring length becomes longer than λg/2.

As is clear from the upper graph of FIG. 8, since the amplitude of the reflected wave varies with the wiring length of the strip wiring 108 connecting the common electrodes, the amplitude distribution can be adjusted to the Taylor distribution by adjusting the wiring length of the strip wiring 108 in the unit cell array 20A. That is, the amplitude of the unit cell array 20A can be fitted to the Taylor distribution by shortening the wiring length of the strip wiring 108 so that the amplitude of the reflected wave of the unit cell 10A disposed outside becomes smaller than the amplitude of the reflected wave of the unit cell 10A disposed in the center of the unit cell array 20A.

In order to fit the amplitude of the unit cell array 20A to the Taylor distribution, it is preferable that the number of the unit cells 10A is larger. However, since the appropriate length of the unit cells 10A (the size of the common electrode 102) is determined by the frequency (wavelength) of the target radio wave, the number of units that can be provided in one unit cell array 20A is limited. In the case of the intelligent reflecting surface (reflect array) 100A according to the present embodiment, when the number of unit cells 10A is 10 or more, preferably 16 or more, the amplitude distribution can be fitted to the Taylor distribution.

The shortest wiring length of the strip wiring 108 is the spacing Wy of the common electrode 102, and cannot be shorter than that. However, in order to reduce the amplitude to fit the Taylor distribution, it is sometimes necessary to make the wiring length of the strip wiring 108 smaller than the spacing Wy of the common electrodes in the simulation. In this case, it is possible to similarly reduce the amplitude of the radio wave reflected by the unit cell 10A by making the wiring length of the strip wiring longer than λg/2.

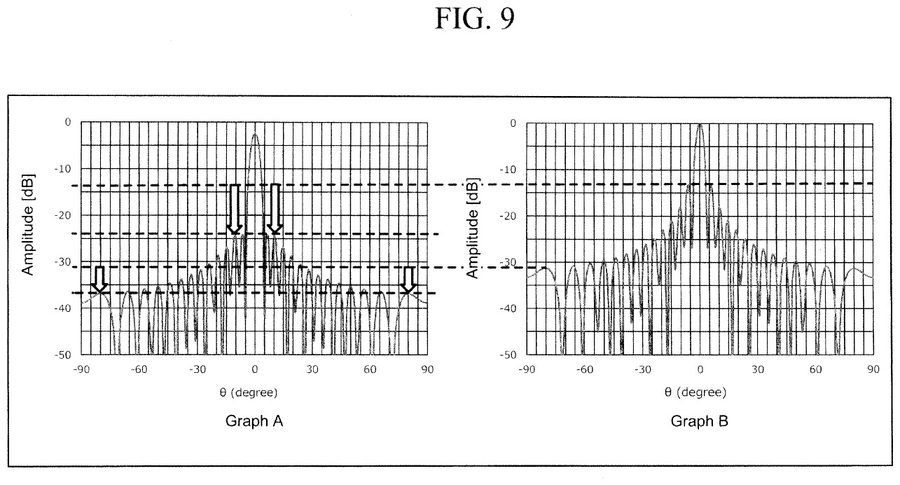

FIG. 9 shows the result of calculating the array factor of the one-dimensional unit cell array. Here, the array factor D (θ) is obtained as follows according to Reference 2 (Kikuma Nobuyoshi, Fundamentals of Array Antennas, 2009 Microwave Exhibition Workshops and Exhibition, Tutorial 3 (2009)).

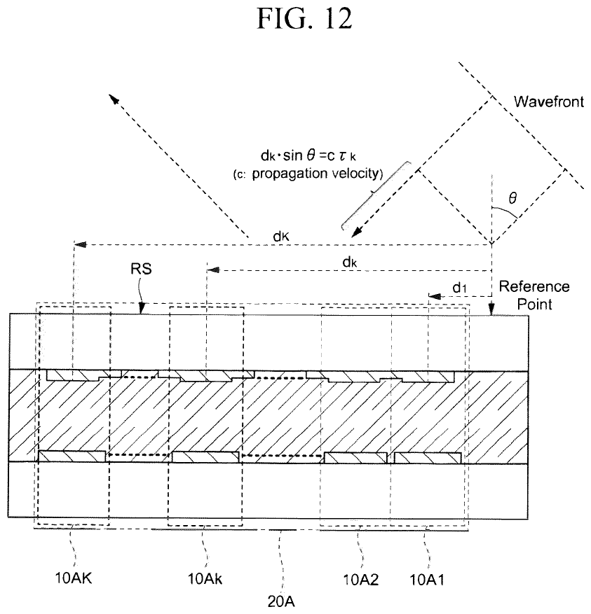

The unit cells 10A of the intelligent reflecting surface (reflect array) 100A are arranged in a matrix as shown in FIG. 1, but here, consider the unit cell array 20A in which the unit cells 10A1 to 10AK are arranged in the Y-axis direction as shown in FIG. 12. It is assumed that the radio wave is incident at an angle θ with respect to the normal direction of the reflection surface RS of the unit cell array 20A. Assuming that the incoming radio wave at the reference point of the reflecting surface RS is E0, the directivity function g (θ) of the unit cell 10A, and the radio wave incident on the unit cell array 20A has a narrow band, a voltage induced in the k-th unit cell 10Ak is given by equation (8).

$${E}_{k} = {E}_{0} g ( θ ) exp ( - j \frac{2 π}{λ} {d}_{k} sin θ ) \qquad ( 8 )$$

$$( k = 1 , 2 K )$$

Where λ is the wavelength of the radio wave and dₖ is the position of the k-th unit cell measured from the reference point.

An intensity Eₛᵤₘ of the radio wave reflected by the unit cell array 20A is given by equation (9) and equation (10).

$${E}_{s u m} = {E}_{0} g ( θ ) D ( θ ) \qquad ( 9 )$$

$$D ( θ ) = {\sum }_{K = 1}^{K} {A}_{k} exp \{ j ( - j \frac{2 π}{λ} {d}_{k} sin θ + {δ}_{k} ) \} \qquad ( 10 )$$

Where Aₖ and σₖ are weights (amplitudes of each unit cell obtained by Taylor distribution) and phase shift amounts applied to the k-th unit cell, and D (θ) is an array factor.

Referring to FIG. 9, the graph A shows the directivity pattern based on the array factor when the wiring length of the strip wiring in the unit cell array 20A is sequentially shortened from the center toward the edge to fit the Taylor distribution, and the graph B shows the case where the wiring length of the strip wiring is constant within the unit cell array. It is apparent from a comparison of the graph A and the graph B that fitting the amplitude distribution of the unit cell array 20A to the Taylor distribution reduces the level of the side lobes on either side of the main lobe by about 10 dB.

The intelligent reflecting surface (reflect array) 100A according to the present embodiment has a configuration in which a bias voltage for controlling the orientation of the liquid crystal layer 106 is applied to each unit cell 10A arranged in a matrix, so that the reflection direction of radio waves can be controlled in the left-right direction, the vertical direction, and the oblique direction. Therefore, it is possible to reduce the level of the side lobe in the reflected wave by setting the length of the strip wiring 108 so that the amplitude of the reflected wave fits the Taylor distribution in accordance with the direction in which the radio wave is reflected.

The intelligent reflecting surface (reflect array) 100A according to the present embodiment can prevent deterioration of the radiation pattern of the reflected wave by changing the length of the strip wiring 108 connecting the common electrodes 102 arranged in a matrix on the incident surface side of the radio wave from the center part toward the outer part. More specifically, the lengths of the strip wirings 108 connected along the X-axis direction or Y-axis direction of the common electrodes 102 arranged in a matrix are made different from the center of the arrangement toward the outside, and the amplitude distribution of the reflected radio wave is fitted to the Taylor distribution, thereby reducing the side lobe level and suppressing the deterioration of the radiation pattern of the reflected wave.

### Second Embodiment

This embodiment shows an intelligent reflecting surface (reflect array) 100B in which the configuration of the common electrode 102 and the bias electrode 104 is different from that of the first embodiment. In the following description, the difference from the first embodiment will be mainly described, and overlapping parts will be appropriately omitted.

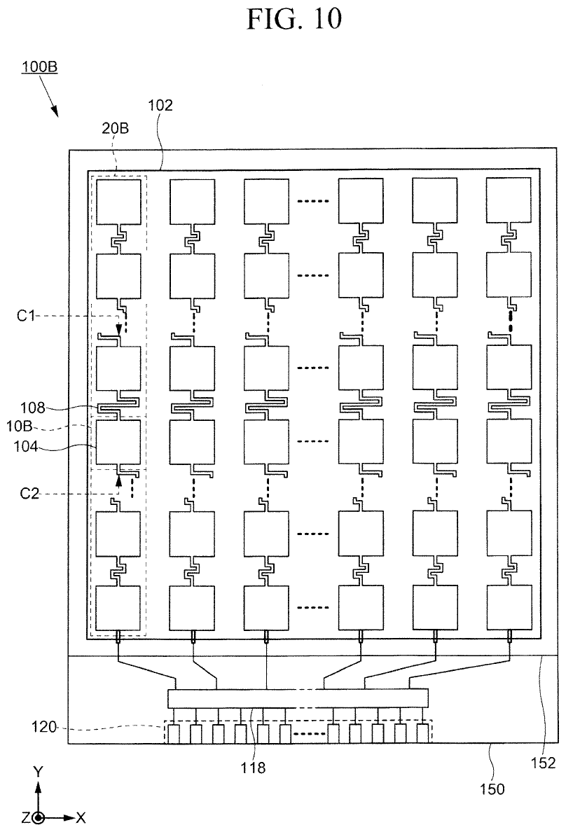

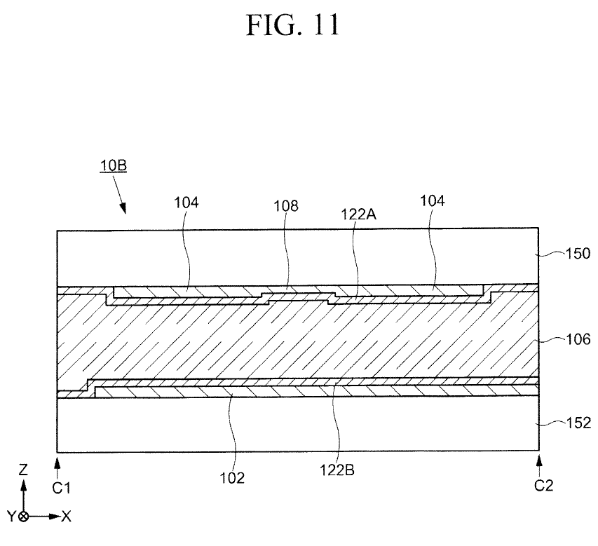

FIG. 10 shows a plan view of an intelligent reflecting surface (reflect array) 100B according to the present embodiment. FIG. 11 shows a cross-sectional view corresponding to C1-C2 of the (reflect array) 100B shown in FIG. 10. In the following description, FIG. 10 and FIG. 11 are referred to as appropriate.

The intelligent reflecting surface (reflect array) 100B includes a bias electrode 104 disposed on the incident surface side of the radio wave and a common electrode 102 disposed on the back side of the bias electrode 104 across the liquid crystal layer 106. The bias electrodes 104 are arranged in a matrix on the side of the first substrate 150, and the common electrodes 102 are disposed on the side of the second substrate 152 to overlap the bias electrodes 104. The common electrode 102 has a size covering the whole of the bias electrodes 104 arranged in a matrix. The common electrode 102 has a size that overlaps the entire area in which the bias electrodes 104 are arranged in a matrix. The intelligent reflecting surface (reflect array) 100B is composed of a unit cell 10B in which a laminated structure (which may include the first substrate 150 and the second substrate 152) of a bias electrode 104, a liquid crystal layer 106, and the common electrode 102 is a basic unit. The intelligent reflecting surface (reflect array) 100B can be said to have a configuration in which the unit cells 10B are arranged in a matrix. The common electrode 102 has a size that extends over the entire intelligent reflecting surface 100B so as to be shared by the plurality of unit cells 10B.

The plurality of bias electrodes 104 are connected to adjacent ones along the X-axis direction or Y-axis direction by strip wiring 108. FIG. 10 shows an example of the plurality of bias electrodes 104 connected along the Y-axis direction by strip wiring 108. A bias signal that aligns the orientation state of the liquid crystal layer 106 is applied to the bias electrodes 104. Therefore, a bias signal is applied to the bias electrode 104 for each array in the Y-axis direction. The first substrate 150 may be provided with a bias signal line driver circuit 118 that applies a bias signal to the bias electrode 104 for each array in the Y-axis direction.

As shown in FIG. 10, the strip wiring 108 connecting adjacent bias electrodes 104 has different lengths in the center and outside in the Y-axis direction of the array of bias electrodes 104, as in the first embodiment. For example, the length of the strip wiring 108 is shorter toward the outside in the Y-axis direction of the array of the bias electrodes 104 in relation to the length of the center part. In other words, as in the first embodiment, the length of the strip wiring 108 is different in the unit cell array 20B so that the amplitude distribution of the reflected wave fits to the Taylor distribution.

The intelligent reflecting surface (reflect array) 100B according to the present embodiment has a configuration in which a bias voltage is applied to the unit cell array 20B, which is arranged in the Y-axis direction, to control the orientation control of the liquid crystal layer 106, and it is possible to control the direction of reflection of radio waves in the uniaxial direction (left/right or up/down). FIG. 10 shows a configuration in which unit cell arrays 20B arranged in the Y-axis direction are connected in series by strip wiring 108, but the intelligent reflecting surface (reflect array) 100B according to the present embodiment is not limited to such a configuration, and the unit cell arrays 20B arranged in the X-axis direction may be connected in series by strip wiring.

The intelligent reflecting surface (reflect array) 100B according to the present embodiment has a configuration in which the length of the strip wiring 108 in the Y-axis direction of the bias electrode 104 varies from the center toward the outside to fit the Taylor distribution, so that the same effect as in the first embodiment can be achieved.

The various configurations of the intelligent reflecting surface (reflect array) illustrated as an embodiment of the present invention may be appropriately combined as long as they are not mutually contradictory. Furthermore, based on the intelligent reflecting surface (reflect array) disclosed in this specification and FIG. 1, any configuration where a person skilled in the art appropriately adds, deletes, or modifies the design of components, or adds, omits, or changes the conditions of processes, is also included within the scope of the present invention as long as it embodies the essence of the present invention.

It is understood that other advantageous effects, even if different from those provided by the embodiments disclosed herein, are naturally provided by the present invention if they are apparent from the description herein or readily foreseeable by those skilled in the art.

What is claimed is:

1. An intelligent reflecting surface comprising:
a plurality of common electrodes arranged in a matrix in a first direction and a second direction intersecting the first direction;
a plurality of bias electrodes overlapping the plurality of common electrodes;
a liquid crystal layer between the plurality of common electrodes and the plurality of bias electrodes; and
a strip wiring connecting the plurality of common electrodes in series in an array in the first direction or the second direction,
wherein the strip wiring includes a first wiring length for connecting pairs of common electrodes disposed in a center part and a second wiring length different from the first wiring length for connecting pairs of common electrodes disposed in an outer part, in the array of the plurality of common electrodes in the first direction or the second direction.

2. The intelligent reflecting surface according to claim 1, wherein the first wiring length is longer than the second wiring length.

3. The intelligent reflecting surface according to claim 2, wherein the first wiring length has a length equal to half (½) of a wavelength λg given by equation (1).
$$λ g = \frac{λ}{{( {ε}_{s} )}^{\frac{1}{2}}} \qquad ( 1 )$$
Here, λ is a wavelength of an incident wave, and εₛ is an average dielectric constant when the liquid crystal layer has positive dielectric constant anisotropy.

4. The intelligent reflecting surface according to claim 1, wherein the wiring length of the strip wiring varies in the array in the first direction or the second direction so as to have a Taylor distribution type amplitude characteristic of a radio wave reflected by the plurality of common electrodes.

5. The intelligent reflecting surface according to claim 1, wherein the strip wiring has a bending pattern in a plan view.

6. An intelligent reflecting surface comprising:
a plurality of bias electrodes arranged in a matrix in a first direction and a second direction intersecting the first direction;
a common electrode overlapping the plurality of bias electrodes;
a liquid crystal layer between the plurality of bias electrodes and the common electrode; and
a strip wiring connecting the plurality of bias electrodes to each other in an array in the first direction or the second direction,
wherein the strip wiring includes a first wiring length for connecting pairs of bias electrodes disposed in a center part and a second wiring length different from the first length for connecting pairs of bias electrodes disposed in an outer part, in the array of the plurality of bias electrodes in the first direction or the second direction.

7. The intelligent reflecting surface according to claim 1, wherein the first wiring length is longer than the second wiring length.

8. The intelligent reflecting surface according to claim 2, wherein the first wiring length has a length equal to half (½) of a wavelength λg given by equation (1).
$$λ g = \frac{λ}{{( {ε}_{s} )}^{\frac{1}{2}}} \qquad ( 1 )$$
Here, λ is a wavelength of an incident wave, and εₛ is an average dielectric constant when the liquid crystal layer has positive dielectric constant anisotropy.

9. The intelligent reflecting surface according to claim 1, wherein a wiring length of the strip wiring varies in the array in the first direction or the second direction to as to have a Taylor distribution type amplitude characteristic of a radio wave reflected by the plurality of bias electrodes.

10. The intelligent reflecting surface according to claim 1, wherein the strip wiring has a bending pattern in a plan view.
